(19) United States
(12) Patent Application Publication
(10) Pub. No.: US 2011/0151113 A1
(43) Pub. Date: Jun. 23, 2011

(54) COATING FORMULATIONS, COMPOSITIONS AND PROCESSES OF PREPARING AND USING THE SAME

(76) Inventors: Ruolei Wang, Hudson, OH (US); Hemant A. Naik, Twinsburg, OH (US)

(21) Appl. No.: 12/737,941

(22) PCT Filed: Sep. 2, 2009
(86) PCT No.: PCT/US2009/055710

§ 371 Date: Mar. 1, 2011

(30) Foreign Application Priority Data
Sep. 12, 2008 (US) 61096492

(51) Int. Cl. C09D 175/12; C08G 18/32; B05D 5/06; B05D 7/24

(52) U.S. Cl. 427/137; 528/68; 524/590

(57) ABSTRACT

Formulations are provided comprising, at least two parts, such as, a first part comprising at least one polyamine and at least one polyol, the first part being substantially free of polyetheramine; and a second part comprising at least one polyisocyanate, or a first part comprising at least one polyamine, at least one polyol and a catalyst; and a second part comprising at least one polyisocyanate. Also, provided are compositions, such as coating and paint compositions, and methods of preparing and using compositions, including coating and paint compositions and methods.

### BACKGROUND OF THE INVENTION

1. Field of the Invention

The present invention relates to coating compositions as well as coating compositions prepared from formulations including multiple components including at least one component comprising a polymeric isocyanate, also referred to as a polyisocyanate, and at least another component comprising at least one polyamine and at least one polyol. The present invention also relates to pavement marking compositions and methods and apparatus for marking pavement with formulations and compositions prepared from the formulations. By introducing the polyol, this invention provides an approach to control reactivity and curing speed of pavement marking systems and reduces the cost.

2. Discussion of Background Information

As discussed in U.S. Pat. No. 7,297,372 to Li et al., which is incorporated by reference herein in its entirety, coatings have been applied to substrates, both to protect the substrates and to improve the properties of the substrates. For example, and without limitation, coatings have been developed to protect substrates from various environmental conditions and to protect substrates during contact of the substrates with other objects. Moreover, coatings have been developed to improve properties of substrates such as durability, strength, environmental resistance and the like.

In the automotive industry, coatings are used for protecting various components of an automotive vehicle. As an example, coatings are used for protecting vehicle components against cosmetic damage (e.g., degradation, marring, denting) due to corrosion, abrasions, impacts, chemicals, ultraviolet light, thermal cycling or the like. While, it is desirable for such coatings to protect against cosmetic damage, it is also desirable to provide a composition that is relatively easy to handle, and particularly exhibits relatively low volatile emissions. Thus, the present invention provides a composition for forming a coating with improved protection capabilities, ease of handling and relatively low volatile emissions.

Additionally, liquid pavement marking compositions are known that have reflectivity when applied to a surface and dried or cured. Pavement marking compositions, can be applied, for example, to roads, highways, parking lots, and recreational trails, in the form of stripes, bars and markings such as for marking lanes, crosswalks, parking spaces, symbols and legends. The pavement marking composition can be applied as a paint, such as by spraying, to a surface. Also, the composition can be applied in a preformed manner, such as in sheets or tapes, to a surface. See, for example, U.S. Pat. No. 6,166,106 to Purgett et al., which is incorporated by reference herein in its entirety.

As disclosed, for example, in U.S. Pat. No. 6,451,874 to Purgett et al., which is incorporated by reference herein in its entirety, pavement marking stripes, or pavement markings of other shapes, may include reflective optical elements adhered to the pavement surface by the use of a binder, with current traffic paint systems typically using conventional 1.5 n_{η} glass microspheres for retroreflection.

Still further, U.S. Patent Application Publication US 2007/0208156 A1 to Posey et al., which is incorporated by reference herein in its entirety, discloses a process for producing a polymer comprising providing a first component having at least one isocyanate; providing a second component having at least one secondary polyetheramine and at least one second amine; and contacting the first component and the second component so as to form the polymer in order to adjust flexibility of the final polymer. Moreover, this patent publication further discloses that a polyol can be present in the first and/or the second component with a hybrid polymer being formed, such as a polyurea-polyurethane hybrid polymer.

Yet further, U.S. Patent Application Publication US 2007/0208157 A1 to Posey et al., which is incorporated by reference herein in its entirety, discloses a process for forming a polymer by providing a first component having at least one isocyanate and a second component having at least one secondary polyetheramine and at least one aspartic ester amine, with the first component and the second component being contacted so as to form the polymer. Moreover, this patent publication further discloses that a polyol can be present in the first and/or the second component with a hybrid polymer being formed, such as a polyurea-polyurethane hybrid polymer.

U.S. Pat. No. 7,342,056 to Patel et al., which is incorporated by reference herein in its entirety, discloses a composition useful for pavement markings comprising a binder and material selected from the group of fillers, extenders, pigments and combinations thereof; and retroreflective elements. The binder is disclosed as comprising a first component comprising the reaction product of an excess of at least one polyisocyanate and at least one hydroxy group-containing material, and a second component comprising at least one polyamine.

While coatings are known, there is a need for coatings having less shrinkage and less cracking during use. There is also a need for a formulation having multiple components that can be mixed at the time of use, and provide sufficient cure time and tack time particularly to be useful as a pavement marking composition. Moreover, there is a need to achieve such coatings while minimizing reaction steps required to prepare each component in the formulation so as to be able to achieve these characteristics through the use of formulations having reduced requirements for additional reactable components to thereby provide ease of use and formulation.

### SUMMARY OF THE INVENTION

The present invention relates to formulations comprising at least two parts and compositions prepared from these formulations.

The present invention also relates to coating and paint compositions as well as to methods of forming and using such coating and paint compositions.

The present invention provides to a formulation comprising at least two parts, including (a) a first part comprising at least one polyamine and at least one polyol, the first part being substantially free of polyetheramine; and (b) a second part comprising at least one polyisocyanate.

The present invention also provides a formulation comprising at least two parts, including (a) a first part comprising at least one polyamine, at least one polyol and a catalyst; and (b) a second part comprising at least one polyisocyanate.

The at least one polyisocyanate can comprise at least one of bis(4-isocyanatocyclohexyl) methane, diphenylmethane diisocyanate. isophorone diisocyanate, toluene 2,4-diisocyanate, hexamethylene diisocyanate, m-tetramethylxylene diisocyanate, and 1,3-phenylene diisocyanate, such as hexamethylene diisocyanate.

The at least one polyol can comprise at least one polyester polyol.

The at least one polyamine can comprise at least one aspartic ester amine.

The first part can be free of polyetheramine.

The first part can contain a catalyst.

The present invention also relates to compositions prepared by combining the first part and the second part of formulations according to the present invention.

The composition can have a pot life of about 2 to about 8 minutes, and a tack free time of about 5 to about 20 minutes.

The composition can comprise a coating composition or a paint composition.

The present invention also relates to polymers formed by combining the first part and the second part of formulations according to the present invention.

The present invention also relates to methods of marking pavement comprising applying compositions according to the invention to the pavement; and applying reflective material to the composition.

### DETAILED DESCRIPTION OF THE PRESENT INVENTION

The particulars shown herein are by way of example and for purposes of illustrative discussion of the embodiments of the present invention only.

The present invention relates to a formulation and its method of use. For example, the formulation can be used for forming a coating composition, such as a paint composition, and the coating can be, without limitation, a reflective coating composition, such as a reflective paint composition including pavement marking compositions.

The formulation comprises at least a two part formulation, and therefore can be two parts or more than two parts. In use these at least two parts of the formulation will be combined with each other to form a composition, such as, without limitation, a coating composition or a pavement marking composition.

One part of the at least two part formulation, for the sake of non-limiting convenience, is referred to herein as the first part, first component and/or component A. The first part comprises includes at least one polyamine and at least one polyol.

As used herein, polyamine refers to compounds having at least two secondary amine groups each containing at least one active hydrogen (N—H group). Thus, the first component of the formulation includes at least one polyamine including compounds having at least two secondary amine groups.

The polyamine preferably comprises and may consist solely of aliphatic polyamine(s). In order to obtain the preferred reaction rate, the amine component preferably includes and may contain only one or more secondary amines, such as an aspartic ester amine containing secondary amines along the backbone as the polyamine. Moreover, the only amine containing material in the first component can be the at least one polyamine. Preferably, the first component is substantially free of polyetheramine so that the polyetheramine does not contribute to a reaction upon combining of the first part and the second part. More preferably, the first part does not contain a polyetheramine therein.

Moreover, the first part can contain at least one polyol. The polyols can comprise, without limitation, polyether polyols, polyester polyols, polycarbonate polyols, and other polyols, polyol chain extenders, such as 1,4-butane diol Preferred embodiments contain polyester polyols which results in improved chemical and weather resistant properties.

Additionally, the first component can include a catalyst therein, such as without limitation at least one organic tin catalyst to help facilitate the reaction upon mixing the first and second components. Other optional catalysts that may be employed in the present invention include for example organometallic compounds and chelates, alkoxides, carboxylates and tertiary amines; and mixtures thereof. Examples of tin compounds include dibutyltin di(ethylhexanoate), dimethyltin diacetate, dibutyltin diacetate, dibutyl disulfide, dibutyltin mercaptide, dibutyltin bis(mercaptide), dibutyltin dilaurate and mixtures thereof. An example of a tertiary amine includes diazobicyclo[2.2.2]octane DABCO L-33 (Air Products). Some other examples of the catalysts useful in the present invention may include octoate salts of zinc, tin, cobalt, manganese and bismuth; bismuth tris(2-ethylhexanoate), cobalt tris(2-ethylhexanoate), zinc acetylacetonoate, zirconium acetylacetonoate, titanium acetylacetonoate, oleic acid and hexanoic acid; and mixtures thereof. Typical concentrations of the catalysts useful in the present invention may be in the range of form about 0.001 to about 2.000% w/w.

Another part of the formulation, also for the sake of non-limiting convenience, is referred to herein as the second part, second component and/or component B. The second part of the formulation can comprise one or more polyisocyanates, such as polyisocyanates derived from hexamethylene diisocyanate.

Without wishing to be bound by theory, the polyamine can react with the polyisocyanate to generate urea groups; the hydroxy functionality of the polyol reacts with the isocyanate groups to generate urethane groups.

The formulation can also contain non-reactive additives such as diluents, pigments, reflective materials and/or fillers. These non-reactive additives can be included in the first part and/or the second part, or can be added as a separate part.

Also, without wishing to be bound by theory, the use of at least one polyol (such as polyester polyol) in the first part of the formulation allows formation of a hybrid polyurethane-polyurea polymer.

The polyisocyanate in the composition may include a single polyisocyanate or a mixture of two or more different polyisocyanates.

Amounts of polyisocyanate that can be included in the formulation can range up from 5% to about 85% by volume, and more preferably range from about 10% to about 50% by volume. Even more preferably, the polyisocyanate is present in the formulation from

about 20% to about 50% by volume and most preferably from about 25% to about 33% by volume.

Polyisocyanates can comprise various polyisocyanates or combinations of polyisocyantates, including diisocyanates, or a combinations thereof. Thus, the polyisocyanate can include various organic compounds that have two or more reactive isocyanate (—NCO) groups in a single molecule, and can include, for example, aliphatic and/or alicyclic polyisocyanates. Thus, polyisocyanates can include diisocyanates, triisocyanates, tetraisocyanates, etc., and mixtures thereof. Preferably, the polyisocyanate comprises one or more aliphatic polyisocyanates.

Representative examples of polyisocyanates include, without limitation, 4,4′-diisocyanatodiphenylmethane, p-phenylene diisocyanate, 1,3-bis(isocyanatomethyl)-cyclohexane, 1,4-diisocyanatocyclohexane, 1,5-naphthalene diisocyanate, 3,3′-dimethyl-4,4′-biphenyl diisocyanate, 4,4′-diisocyanatodicyclohexylmethane, and 2,4-toluene diisocyanate, or mixtures thereof. More preferred examples include 4,4′-diisocyanato-dicyclohexylmethane and 4,4′-diisocyanatodiphenylmethane, 4,4′-diisocyanatodiphenylmethane, and toluene-2,4,6-triisocyanate. The polyisocyanate can include a liquid aliphatic isocyanate oligomer or prepolymer, such as being based upon dicyclohexylmethane 4,4′-diisocyanate (H₁₂MDI), isophorone diisocyanate (IPDI), tetramethyl-1,3-xylylene diisocyanate (TMXDI), hexamethylene diisocyanate (HDI) or a mixture thereof.

For example, as disclosed in U.S. Pat. No. 6,451,874, which is incorporated by reference herein in its entirety, the polyisocyanate can include, but is not limited to, those selected from bis(4-isocyanatocyclohexyl) methane (H₁₂MDI, available from Bayer Corp., Pittsburgh, Pa.), diphenylmethane diisocyanate (MDI, available from Bayer Corp., Pittsburgh, Pa.), isophorone diisocyanate (IPDI, available from Evonik-Degussa, Piscataway, N.J.), toluene 2,4-diisocyanate (TDI, available from Aldrich Chemical Co., Milwaukee, Wis.), hexamethylene diisocyanate (HDI, available from Aldrich Chemical Co., Milwaukee, Wis.), m-tetramethylxylene diisocyanate (TMXDI, available from Aldrich Chemical Co., Milwaukee, Wis.), and 1,3-phenylene diisocyanate.

Furthermore, while monomeric isocyanates could be useful, they are not preferred, but could be used to make adducts and prepolymers that would be preferred. Polyisocyanates can also include derivatives of monomeric polyisocyanates. These derivatives include, but are not limited to, polyisocyanates containing biuret groups, such as the biuret adduct of hexamethylene diisocyanate (HDI) available from Bayer Corp., Pittsburgh, Pa. under the trade designation “DESMODUR” N-100, polyisocyanates containing isocyanurate groups, such as that available from Bayer Corp., Pittsburgh, Pa. under the trade designation “DESMODUR” N-3300, as well as polyisocyanates containing urethane groups, uretdione groups, carbodiimide groups, allophonate groups, and the like. These derivatives are preferred as they are polymeric and have very low vapor pressures and negligible free isocyanate monomer.

There are many useful commercially available adducts of the monomeric isocyanates. There are also many useful adducts and prepolymers that are not presently commercially available that could be prepared, such as for example, the reaction products of the above mentioned aspartic ester amines with diisocyanates such as IPDI, TMXDI, and the like. See, for example, U.S. Pat. No. 6,166,572, which is incorporated by reference herein in its entirety.

Preferred polyisocyanates include HDB-LV from Rhodia, and HDB from Rhodia

As discussed above, the at least one polyamine includes compounds having at least two secondary amine groups. One or more primary amines groups (NH₂ group) can also be present as long as there are at least two secondary amine groups (NH group) present. The polyamine preferably includes one or more aliphatic polyamines, and can comprise only one or more aliphatic polyamines. Preferably, the polyamine comprises an aspartic ester amine. Suitable aspartic ester amines are commercially available from Bayer Corp. under the trade designation “Desmophen NH 1420”, “Desmophen NH 1520” and “Desmophen NH 1220”. Other aliphatic diamines that may be useful include for example lower reactivity diamines such as commercially available from Dorf Ketal, Tex. under the trade designation “Clearlink 1000 Diamines”, PolyClear 136 from BASF corporation, NJ and a cycloaliphatic bis(secondary amine) such as commercially available from Huntsman, Houston, Tex. under the trade designation “Jefflink 754 Diamine”.

Preferred aspartic ester amines can be those such as disclosed, for example, in U.S. Pat. No. 7,342,056, the disclosure of which is incorporated by reference herein in its entirety, having the following Formula I:

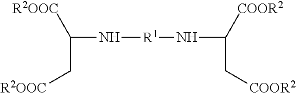

wherein R¹ is a divalent organic group (preferably, having 1-40 carbon atoms), and each R² is independently an organic group inert toward isocyanate groups at temperatures of 100° C. or less.

In the above formula, preferably, R¹ is an aliphatic group (preferably, having 1-40 carbon atoms), which can be branched, unbranched, or cyclic, and more preferably, R¹ is selected from the group of divalent hydrocarbon groups obtained by the removal of the amino groups from 1,4-diaminobutane, 1,6-diaminohexane, 2,2,4- and 2,4,4-trimethyl-1,6-diaminohexane, 1-amino-3,3,5-trimethyl-5-aminomethyl-cyclohexane, 4,4′-diamino-dicyclohexyl methane or 3,3-dimethyl-4,4′-diamino-dicyclohexyl methane. Divalent groups obtained by the removal of the amino groups from relatively high molecular weight polyether polyamines such as the products marketed under the trade designation “Jeffamine” by Huntsman LLC, Houston, Tex., and amine terminated butadiene-acrylonitrile polymers sold under the tradename “HYPRO” by Emerald Performance

Materials, Akron, Ohio, are also suitable. Other suitable polyamine precursors include ethylene diamine, 1,2-diaminopropane, 2,5-diamino-2,5-dimethylhexane, 1,11-diaminoundecane, 1,12-diaminododecane, 2,4- and/or 2,6-hexahydrotoluoylene diamine, and 2,4′-diamino-dicyclohexyl methane. Aromatic polyamines such as 2,4- and/or 2,6-diaminotoluene and 2,4′- and/or 4,4′-diaminodiphenyl methane are also suitable but less preferred.

In the above formula, preferably, each R² is independently an organic group having 1-40 carbon atoms, more preferably, each R² is independently an alkyl group (preferably, having 1-20 carbons), which may be branched or unbranched, and most preferably, each R² is independently a lower alkyl group (having 1-4 carbon atoms).

One or more amine-functional coreactants can be used in addition to the aspartic ester amines. These amines (other than aspartic ester amines) typically function as chain extenders and/or impact modifiers. The use of such amine-functional coreactant(s) can contribute to the presence of soft segments in the polymer backbone for improved toughness properties. Such amine-functional coreactants can be primary amines, secondary amines, or combinations thereof. Secondary amines, a blend of secondary amines, or a blend of secondary amines and primary amines can be used.

The amine-functional coreactant is preferably an amine-terminated polymer. Examples of such polymers include, but are not limited to, those available from Huntsman Chemical, under the trade designation “Jeffamine” polypropylene glycol diamines such as “Jeffamine XTJ-510”, those available from Emerald Performance Materials, Akron, Ohio, under the trade designation “HYPRO” ATBN (amine-terminated acrylonitrile butadiene copolymers), and those disclosed in U.S. Pat. No. 3,436,359 (Hubin et al.) and U.S. Pat. No. 4,833,213 (Leir et al.) (amine-terminated polyethers, and especially polytetrahydrofuran diamines), which are incorporated by reference herein.

As discussed above, the first component also comprises at least one polyol. The polyol can be a hydroxyl terminated lactone intermediate, and/or a hydroxyl terminated polyether, polyester, or a polyether-ester intermediate. The polyester intermediate is generally made from glycols or triols having from about 2 to about 10 and desirably from about 2 to about 6 carbon atoms, with specific examples including ethylene glycol, propylene glycol, butylenes glycol, hexamethylene glycol, trimethanol propane, and the like, with ethylene glycol and propylene glycol being preferred. Although, for example, a polyether polyol, polylactone polyol or a polyester polyol can be utilized, preferably a polyester-ether intermediate is utilized made from ester and ether forming polyol compounds and preferably a branched polyester-ether intermediate is utilized desirably having at least two hydroxyl end groups therein. Desirably, the mixed polyester-ether is multifunctional as containing from about 2 to about 3 hydroxyl groups therein and preferably is trifunctional. The equivalent weight of the polyether, the polyester, or the polyether-ester intermediate is generally from about 190 to about 500 and preferably from about 300 to about 400. See, for example, U.S. Pat. No. 3,534,652 which is incorporated by reference herein.

One preferred class of polyols are polyester polyols prepared from dimer acid. Dimer acid is the product of dimerization of an 18 carbon unsaturated fatty acid resulting in a 36 carbon diacid product. Typically, a mixture of unsaturated acids are dimerized resulting in a mixture of 36 carbon diacids. Preferred dimer acid based polyols are hydrogenated resulting in low color. Several polyester polyols prepared from dimer acid are commercially available from Uniqema Corporation, New Castle, Del. under the trade designation “Priplast”.

Dimer diol is obtained by reduction of the carboxylic acids and residual unsaturation of dimer acid, providing a 36 carbon hydrocarbon diol. Dimer diol is commercially available from Uniqema Corporation under the trade designation “Pripol 2033”.

Preferred polyester polyols include branched hydroxyl-terminated saturated polyester from Chemtura under the trade designation “Fomrez 1066-187”, “Fomrez 66-225”, “Fomrez 11-225”, polycapolactone polyester diol from Perstorp under the trade designation “CAPA 2054”, “CAPA 2085”, “CAPA 2077A”, “CAPA 3091”, “CAPA 3031”.

In embodiments of the present invention, the reactivity and properties of the polymer can be adjusted through proper control of the ratio of the polyamine to the polyol. Generally, a polyol, has a lower reactivity with isocyanate. Catalysts, such as organic tin catalysts, such as dibutyl tin dilaurate (DBTDL) or tributyl tin dilaurate (TBTDL), can be used to facilitate the reaction. Therefore, by adjusting the amount of polyol and tin catalysts in the first part component, the reactivity of hybrid polyurea/polyurethane system will be controlled. The reduction in the speed of the production of polymers according to the present invention is an advantage of embodiments of the present invention. Slower cure rate allows the pavement marking system having more time to wet the substrate and therefore providing better bonding strength between the coating and substrate. Moreover, a slower curing rate, permits particles, such as reflective particles, to adhere to the coating upon subsequent application to an applied coating Also since polyol may be a fraction of the cost of polyamine, such as aspartic ester amine, production costs can be saved by using one or more polyols, as a substitute for the polyamine, such as an aspartic ester amine.

The weight ratio of the polyamine, such as aspartic ester secondary amine, parts to the polyol parts, not including any other parts of the compositions and wherein both parts equal 100, may range from about 0.1:99.9 to about 99.9:0.1, and more preferably from about 5.0:95.0 to about 95.0:5.0. Even more preferably, the weight ratio of the polyamine parts to the polyol parts is from about 25.0:75.0 to about 80.0:20.0 and even more preferably from about 40.0:60.0 to about 75.0:25.0. The amount of polyisocyanate present in the formulation for the polyurea/polyurethane reaction is preferably in excess based upon a ratio of equivalents of isocyanate to equivalents of polyamine/polyol compound. For example, preferably, the polyisocyanate:polyamine/polyol weight ratio is less than about 1.15:1, more preferably, the polyisocyanate:polyamine/polyol weight ratio is less than about 1.1:1, and most preferably the polyisocyanate:polyamine/polyol weight ratio is less than about 1.05:1.

Additional ingredients can be added to either or both of the of the at least two components and/or can be a separate additional component of the formulation. Thus, as noted above, the formulation can comprise two components or more than two components. Additives can include additives such as disclosed in U.S. Pat. No. 5,340,652, which is incorporated by reference herein. For example, various additives can be used to achieve desirable results. For example, weathering additives such as UV absorbers, hindered amine light stabilizers, antioxidants, dispersing and grinding aids, wetting agents, impact modifiers, defoamers (such as BYK 501 from Byk-Chemie), catalysts (such as T-12 from Air Products, Cotin 200 and Coscat 28 from CasChem), molecular sieves (such as UOP Powder from UOP LLC), suspension stabilizers, biocides can be added to the binder to improve the manufacturability and the overall durability.

Also, pigments, including but not limited to TiO₂ (such as Kronos 2160 from Kronos); fillers including but not limited to talc (such as Nytal 300 from R.T. Vanderbilt), CaCO₃, clay, ceramic microspheres, hollow polymeric microspheres (Extendosphere XOL-150 from Sphere One, Inc.), and hollow glass microspheres; extenders; diluents; plasticizers; leveling agents, and surfactants can be included in the formulation. Pigments (such as organic yellow 65, organic yellow 74 and organic yellow 83) can impart desired visual appearance properties in the daytime as well as contribute to reflective performance of the coating under different lighting conditions. Fillers and extenders can be used to modify flow properties of the liquid coating and contribute to the bulk volume of the final coating with lower cost per volume materials.

The additional ingredients can comprise, for example, from about 15 to about 40% by weight of the combined composition/coating.

When the formulation of the present invention is used as a reflective pavement marking material, it preferred that the formulation be combined into a coating composition, with the coating composition being placed upon the surface to be marked, and preferably thereafter the reflective additives be placed on the coating composition. For example, the coating composition can be applied directly to a traffic bearing surface with or without a primer layer or to a substrate that is applied to the surface. This can be done using spray coating techniques. Typically, the first component and the second component are applied using a spraying apparatus that allows the components to combine immediately prior to exiting the apparatus. For example, two-component, high pressure, airless, impingement mixing systems can be used. Also, plural component spray equipment with a static mixer can be used.

The reflective additives, can be, but are not limited to, reflective particles, such as reflective microspheres, such as ceramic particles or glass particles. Preferably, the reflective additives comprise glass particles such as those manufactured by Swarco Holdings AG including for exampleMegalux (600-1700 micrometers), Plus 9 Cluster beads (500-1500 micrometers), Swarcolux (75-1400 micrometers), and Reflex (45-850 Micrometers); and such as those manufactured by Potters Industries including for example Highway safety spheres, Visibead, Ultra 1.9, and Visimax. The refractive index of the glass particles is preferably about 1.5 or greater, can be about 1.9 or greater, and can be about 2.3 or higher to comprise a wet reflective. Generally, the reflective elements do not exceed about several millimeters in diameter. The ceramic or glass particles may be treated with additives to enhance adhesion, flotation and other beneficial properties.

Viscosity behavior of each of the two components is a consideration for two part spray coating processes as well as for pavement markings, such as by applying reflective elements. With impingement mixing, the two parts should be as close as possible in viscosity at high shear rates to allow adequate mixing and even cure. The plural component static mix/spray system appears to be more forgiving of viscosity differences between the two components. Characterization of viscosities as functions of shear rate and temperature can help with decisions as to starting point for temperatures and pressures of the coatings in the two part spray equipment lines. (Viscosity will also be a concern for the reflective elements embedment. The desired viscosity can be from about 3,000 cps to about 40,000 cps at 25° C. using a Brookfield viscometer, spindle 4 at 60 rpm or 12 rpm.

The pot life of the formulation upon mixing of the at least two components can be about 2 to about 8 minutes, more preferably about 3 to about 5 minutes using ASTM C-881 modified to use 100 g. The tack free time of the formulation upon mixing of the at least two components can be about 5 to about 20 minutes, more preferably about 5 to about 8 minutes using ASTM D-711.

The ceramic beads or other reflective microspheres can be applied directly to the binder coated on the pavement surface. Alternatively, they can be applied in the form of retroreflective optical elements having vertical surfaces. Vertical surfaces provide better orientation for retroreflection. Also, they may prevent the build-up of a layer of water over the retroreflective surface during rainy weather, which otherwise interferes with the retroreflection mechanism.

The various additives, including various reflective materials, that can be added in the present formulation can be those as described, for example, in U.S. Pat. No. 6,451,874 B1 to Purgett et al., which is incorporated by reference herein in its entirety.

### EXAMPLES

The following examples are for illustrative purposes only and are not intended to limit the scope of the present invention. Unless otherwise stated, the units are percent by weight.

### Examples 1-8

In the Examples, as illustrated in Tables 1-8, the components listed in Part A of the Tables including a polyaspartic amine and a polyester polyol, as listed in the Tables, were mixed with other listed components for about 8 to about 9 minutes. Thereafter, additional components, as listed, were added, and the resulting mixture was mixed for about 10 to about 15 minutes at high speed obtaining a viscosity as listed in the Tables.

Thereafter, the component listed in Part B of Tables 1-8 for each Example was added. The resulting product was subjected to the listed test conditions, and the results of the tests are illustrated in each of the Tables for each of the Examples.

TABLE 1
Example 1

| | Trade name | Chemical name-function | Supplier | % w/w |
|---|---|---|---|---|
| PART A | | | | |
| Desmophen NH | Desmophen NH | Polyaspartic Amine | Bayer | 42.82% |
| 1420 | 1420 | | | |
| Fomrez 1066-187 | Fomrez 1066-187 | TMP based polyester polyol | Chemtura | 14.27% |
| BYK 501 | BYK 501 | Defoamer | Byk-Chemie | 0.06% |
| T-12 | T-12 | dibutyltin dilaurate catalyst | Air Products | 0.03% |

Mix for 8~9 minutes

| UOP Powder | | molecular sieve-moisture scavenger | UOP LLC | 0.50% | |
|---|---|---|---|---|---|
| TiO2 | Kronos 2160 | titanium dioxide | Kronos | 22.84% | |
| | | pigment | | | |
| Talc | Nytal 300 | Filler | R. T. Vanderbilt | 19.48% | |
| | Mix for 10~15 minutes @ high speed | | | | |
| | | | | 100.00% | |
| Viscosity | | | | 4650 | cp |
| | | | | 12.32 | lb/gal |
| PART B | | | | | |
| HDB-LV | HDB-LV | HDI polyisocyanate | Rhodia | 100% | |
| Viscosity | | | | 2000~3000 cp | |
| | | | | 9.32 | lb/gal |

| Properties | Test Method | Result | |
|---|---|---|---|
| Mixing Ratio | | A:B::2:1 (vol) | |
| Pot Life | ASTM C-881 | 2~3 | min |
| | (modified to use 100 g.) | | |
| Tack Free | ASTM D-711 | 6~7 | min |
| Hardness | ASTM D-2240 | 78~80 | |
| Tensile | ASTM D-638 | 4000 | psi |
| Abrasion Resistance | ASTM D-4060 | 77.3 | mg |
| Retroreflectivity | | 300~400 | mcd/m²/lux |

(20 mil, double drop,
10 lb/gal IV & 10 lb/gal I)

TABLE 2
Example 2

| | Trade name | Chemical name-function | Supplier | % w/w |
|---|---|---|---|---|
| PART A | | | | |
| Desmophen NH | Desmophen NH | Polyaspartic Amine | Bayer | 48.41% |
| 1420 | 1420 | | | |
| CAPA 2077A | CAPA 2077A | polycaprolactone polyester polyol | Perstorp | 16.14% |
| BYK 66 | BYK 66 | Defoamer | Byk-Chemie | 0.07% |
| T-12 | T-12 | dibutyltin dilaurate catalyst | Air Products | 0.03% |

Mix for 8~9 minutes

| UOP Powder | | molecular sieve-moisture scavenger | UOP LLC | 0.45% | |
|---|---|---|---|---|---|
| TiO2 | Kronos 2160 | titanium dioxide pigment | Kronos | 25.82% | |
| Talc | Nytal 300 | Filler | R. T. Vanderbilt | 9.08% | |
| | Mix for 10~15 minutes @ high speed | | | | |
| | | | | 100.00% | |
| Viscosity | | | | 2000 | cp |
| | | | | 11.74 | lb/gal |
| PART B | | | | | |
| HDB-LV | HDB-LV | HDI polyisocyanate | Rhodia | 100% | |
| Viscosity | | | | 2000~3000 cp | |
| | | | | 9.32 | lb/gal |

| Properties | Test Method | Result | |
|---|---|---|---|
| Mixing Ratio | | A:B::2:l (vol) | |
| Pot Life | ASTM C-881 | 3~5 | min |
| | (modified to use 100 g.) | | |
| Tack Free | ASTM D-711 | 8~9 | min |
| Hardness | ASTM D-2240 | 78~80 | |
| Tensile | ASTM D-638 | 4300 | psi |
| Abrasion Resistance | ASTM D-4060 | 54.6 | mg |
| Retroreflectivity | | 250~420 | mcd/m²/lux |

(20 mil, double drop,
10 lb/gal IV & 10 lb/gal I)

TABLE 3
Example 3

| | Trade name | Chemical name-function | Supplier | % w/w |
|---|---|---|---|---|
| PART A | | | | |
| Desmophen NH | Desmophen NH | Polyaspartic Amine | Bayer | 38.46% |
| 1420 | 1420 | | | |
| CAPA 3091A | CAPA 3091A | polycaprolactone polyester polyol | Perstorp | 20.71% |
| BYK 501 | BYK 501 | Defoamer | Byk-Chemie | 0.06% |
| T-12 | T-12 | dibutyltin dilaurate catalyst | Air Products | 0.03% |

Mix for 8~9 minutes

| UOP Powder | | molecular sieve-moisture scavenger | UOP LLC | 0.41% | |
|---|---|---|---|---|---|
| TiO2 | Kronos 2160 | titanium dioxide pigment | Kronos | 23.84% | |
| Talc | Nytal 300 | Filler | R. T. Vanderbilt | 16.65% | |
| | Mix for 10~15 minutes @ high speed | | | | |
| | | | | 100.16% | |
| Viscosity | | | | 2400 | cp |
| | | | | 11.34 | lb/gal |
| PART B | | | | | |
| HDB-LV | HDB-LV | HDI polyisocyanate | Rhodia | 100% | |
| Viscosity | | | | 2000~3000 cp | |
| | | | | 9.32 | lb/gal |

| Properties | Test Method | Result | |
|---|---|---|---|
| Mixing Ratio | | A:B::2:l (vol) | |
| Pot Life | ASTM C-881 | 2~3 | min |
| | (modified to use 100 g.) | | |
| Tack Free | ASTM D-711 | 6~7 | min |
| Hardness | ASTM D-2240 | 73~75 | |
| Tensile | ASTM D-638 | 2050 | psi |

TABLE 4
Example 4

| | Trade name | Chemical name-function | Supplier | % w/w |
|---|---|---|---|---|
| PART A | | | | |
| Desmophen NH | Desmophen NH | Polyaspartic Amine | Bayer | 38.46% |
| 1420 | 1420 | | | |
| FOMREZ 1066-187 | FOMREZ 1066-187 | TMP based polyester polyol | Chemtura | 20.71% |
| BYK 66 | BYK 501 | Defoamer | Byk-Chemie | 0.06% |
| T-12 | T-12 | dibutyltin dilaurate catalyst | Air Products | 0.03% |

Mix for 8~9 minutes

| UOP Powder | | molecular sieve-moisture scavenger | UOP LLC | 0.41% | |
|---|---|---|---|---|---|
| TiO2 | Kronos 2160 | titanium dioxide pigment | Kronos | 23.84% | |
| Talc | Nytal 300 | Filler | R. T. Vanderbilt | 16.65% | |
| | Mix for 10~15 minutes @ high speed | | | | |
| | | | | 100.16% | |
| Viscosity | | | | 5050 | cp |
| | | | | 12.38 | lb/gal |
| PART B | | | | | |
| HDB-LV | HDB-LV | HDI polyisocyanate | Rhodia | 100% | |
| Viscosity | | | | 2000~3000 cp | |
| | | | | 9.32 | lb/gal |

| Properties | Test Method | Result | |
|---|---|---|---|
| Mixing Ratio | | A:B::2:l (vol) | |
| Pot Life | ASTM C-881 | 2~3 | min |
| | (modified to use 100 g.) | | |
| Tack Free | ASTM D-711 | 6~7 | min |
| Hardness | ASTM D-2240 | 78~80 | |
| Tensile | ASTM D-638 | 2800 | psi |
| Abrasion Resistance | ASTM D-4060 | 87.6 | mg |

Retroreflectivity

TABLE 5
Example 5

| | Trade name | Chemical name-function | Supplier | % w/w |
|---|---|---|---|---|
| PART A | | | | |
| Desmophen NH | Desmophen NH | Polyaspartic Amine | Bayer | 44.44% |
| 1420 | 1420 | | | |
| CAPA 2077A | CAPA 2077A | polycaprolactone polyester polyol | Perstorp | 14.81% |
| BYK 66 | BYK 501 | Defoamer | Byk-Chemie | 0.06% |
| T-12 | T-12 | dibutyltin dilaurate catalyst | Air Products | 0.03% |

Mix for 8~9 minutes

| UOP Powder | | molecular sieve-moisture scavenger | UOP LLC | 0.41% | |
|---|---|---|---|---|---|
| TiO2 | Kronos 2160 | titanium dioxide pigment | Kronos | 23.70% | |
| Talc | Nytal 300 | Filler | R. T. Vanderbilt | 9.08% | |
| | Mix for 10~15 minutes @ high speed | | | | |
| Extendospheres | Extendospheres | Aluminosilicate hollow sphere | Sphere One, Inc. | 7% | |
| XOL-150 | XOL-150 | | | | |
| | | | | 99.96% | |
| Viscosity | | | | 9400 | cp |
| | | | | 8.52 | lb/gal |
| PART B | | | | | |
| HDB | HDB | HDI polyisocyanate | Rhodia | 100% | |
| Viscosity | | | | 7000~9000 cp | |
| | | | | 9.32 | lb/gal |

| Properties | Test Method | Result | |
|---|---|---|---|
| Mixing Ratio | | A:B::3:l (vol) | |
| Pot Life | ASTM C-881 | 3~5 | min |
| | (modified to use 100 g.) | | |
| Tack Free | ASTM D-711 | 8~9 | min |
| Hardness | ASTM D-2240 | 78~80 | |
| Tensile | ASTM D-638 | 2800 | psi |
| Abrasion Resistance | ASTM D-4060 | 83.6 | mg |
| Compressive Strength | ASTM D-695 | 5600 | psi |

TABLE 6
Example 6

| | Trade name | Chemical name-function | Supplier | % w/w |
|---|---|---|---|---|
| PART A | | | | |
| Desmophen NH | Desmophen NH | Polyaspartic Amine | Bayer | 40.57% |
| 1420 | 1420 | | | |
| Fomrez 1066-187 | Fomrez 1066-187 | TMP based polyester polyol | Chemtura | 13.52% |
| BYK 501 | BYK 501 | Defoamer | Byk-Chemie | 0.05% |
| T-12 | T-12 | dibutyltin dilaurate catalyst | Air Products | 0.03% |

Mix for 8~9 minutes

| UOP Powder | | molecular sieve-moisture scavenger | UOP LLC | 0.38% | |
|---|---|---|---|---|---|
| TiO2 | Kronos 2160 | titanium dioxide pigment | Kronos | 21.64% | |
| Talc | Nytal 300 | Filler | R. T. Vanderbilt | 18.35% | |
| | Mix for 10~15 minutes @ high speed | | | | |
| Extendospheres | Extendospheres | Aluminosilicate hollow sphere | Sphere One, Inc. | 5% | |
| XOL-150 | XOL-150 | | | | |
| | | | | 99.99% | |
| Viscosity | | | | 22250 | cp |
| | | | | 9.73 | lb/gal |
| PART B | | | | | |
| HDB | HDB | HDI polyisocyanate | Rhodia | 100% | |
| Viscosity | | | | 7000~9000 cp | |
| | | | | 9.32 | lb/gal |

| Properties | Test Method | Result | |
|---|---|---|---|
| Mixing Ratio | | A:B::3:l (vol) | |
| Pot Life | ASTM C-881 | 2~3 | min |
| | (modified to use 100 g.) | | |
| Tack Free | ASTM D-711 | 5~7 | min |
| Hardness | ASTM D-2240 | 78~80 | |
| Tensile | ASTM D-638 | 3100 | psi |
| Abrasion Resistance | ASTM D-4060 | 65.8 | mg |
| Compressive Strength | ASTM D-695 | 6500 | psi |

TABLE 7
Example 7

| | Trade name | Chemical name-function | Supplier | % w/w |
|---|---|---|---|---|
| PART A | | | | |
| Desmophen NH | Desmophen NH | Polyaspartic Amine | Bayer | 41.05% |
| 1420 | 1420 | | | |
| CAPA 2077A | CAPA 2077A | polycaprolactone polyester polyol | Perstorp | 13.68% |
| BYK 501 | BYK 501 | Defoamer | Byk-Chemie | 0.05% |
| T-12 | T-12 | dibutyltin dilaurate catalyst | Air Products | 0.03% |

Mix for 8~9 minutes

| UOP Powder | | molecular sieve-moisture scavenger | UOP LLC | 0.38% | |
|---|---|---|---|---|---|
| TiO2 | Kronos 2160 | titanium dioxide pigment | Kronos | 7.89% | |
| Sunglow 1237 | Sunglow 1237 | Yellow pigment 74 | BASF | 6.47% | |
| Sunglow 1244 | Sunglow 1244 | Yellow pigment 65 | BASF | 7.53% | |
| Talc | Nytal 300 | Filler | R. T. Vanderbilt | 18.68% | |
| | Mix for 10~15 minutes @ high speed | | | | |
| Extendospheres | Extendospheres | Aluminosilicate hollow sphere | Sphere One, Inc. | 4.21% | |
| XOL-150 | XOL-150 | | | | |
| | | | | 99.97% | |
| PART B | | | | | |
| HDB | HDB | HDI polyisocyanate | Rhodia | 100% | |
| Viscosity | | | | 7000~9000 cp | |
| | | | | 9.32 | lb/gal |

| Properties | Test Method | Result |
|---|---|---|
| Mixing Ratio | | A:B::3:l (vol) |

TABLE 8
Example 8

| | Trade name | Chemical name-function | Supplier | % w/w |
|---|---|---|---|---|
| PART A | | | | |
| Desmophen NH | Desmophen NH | Polyaspartic Amine | Bayer | 44.44% |
| 1420 | 1420 | | | |
| Fomrez 1066-187 | Fomrez 1066-187 | TMP based polyester polyol | Chemtura | 14.81% |
| BYK 501 | BYK 501 | Defoamer | Byk-Chemie | 0.06% |
| T-12 | T-12 | dibutyltin dilaurate catalyst | Air Products | 0.03% |

Mix for 8~9 minutes

| UOP Powder | | molecular sieve-moisture scavenger | UOP LLC | 0.41% | |
|---|---|---|---|---|---|
| TiO2 | Kronos 2160 | titanium dioxide pigment | Kronos | 8.54% | |
| Sunglow 1237 | Sunglow 1237 | Yellow pigment 74 | BASF | 7.01% | |
| Sunglow 1244 | Sunglow 1244 | Yellow pigment 65 | BASF | 8.15% | |
| Talc | Nytal 300 | Filler | R. T. Vanderbilt | 9.08% | |
| | Mix for 10~15 minutes @ high speed | | | | |
| Extendospheres | Extendospheres | Aluminosilicate hollow sphere | Sphere One, Inc. | 7.47% | |
| XOL-150 | XOL-150 | | | | |
| | | | | 100.00% | |
| PART B | | | | | |
| HDB | HDB | HDI polyisocyanate | Rhodia | 100% | |
| Viscosity | | | | 7000~9000 cp | |
| | | | | 9.32 | lb/gal |

| Properties | Test Method | Result |
|---|---|---|
| Mixing Ratio | | A:B::3:l (vol) |

1. A formulation comprising at least two parts, comprising:
(a) a first part comprising at least one polyamine and at least one polyol, wherein the polyamine comprises a compound having at least two secondary amine groups; and
(b) a second part comprising at least one polyisocyanate.

2. The formulation according to claim 1, wherein the first part, component (a), includes a catalyst.

3. (canceled)

4. The formulation according to claim 1, wherein the at least one polyisocyanate comprises at least one of bis(4-isocyanatocyclohexyl) methane, diphenylmethane diisocyanate. isophorone diisocyanate, toluene 2,4-diisocyanate, hexamethylene diisocyanate, m-tetramethylxylene diisocyanate, and 1,3-phenylene diisocyanate.

5. The formulation according to claim 4, wherein the at least one polyisocyanate comprises hexamethylene diisocyanate.

6. The formulation according to claim 1, wherein the at least one polyol comprises at least one polyester polyol.

7. The formulation according to claim 1, wherein the polyamine comprises at least one aspartic ester amine.

8. The formulation according to claim 1, wherein the first part is free of polyetheramine.

9. A composition prepared by combining the first part and the second part of the formulation of claim 1.

10. The composition according to claim 9, having a pot life of about 2 to about 8 minutes, and a tack free time of about 5 to about 20 minutes.

11. The composition according to claim 9 comprising a coating composition or a paint composition.

12. A polymer formed by combining the first part and the second part of the formulation of claim 1.

13. The polymer of claim 12 having a pot life of about 2 to about 8 minutes, and a tack free time of about 5 to about 20 minutes.

14. A method of marking pavement comprising applying the composition of claim 9 to the pavement; and applying reflective material to the composition.
